(19) United States
(12) Patent Application Publication
(10) Pub. No.: US 2019/0322162 A1
(43) Pub. Date: Oct. 24, 2019

(54) METHOD FOR CONTROLLING LIGHT TRANSMITTANCE

(71) Applicant: KABUSHIKI KAISHA TOKAI RIKA DENKI SEISAKUSHO, Aichi (JP)

(72) Inventor: Keiji MURASE, Aichi (JP)

(73) Assignee: KABUSHIKI KAISHA TOKAI RIKA DENKI SEISAKUSHO, Aichi (JP)

(21) Appl. No.: 16/390,118

(22) Filed: Apr. 22, 2019

(30) Foreign Application Priority Data
Apr. 24, 2018 (JP) 2018-083236

(51) Int. Cl. B60J 3/02; G02F 1/163; G02F 1/153; B60J 3/04

(52) U.S. Cl. CPC B60J 3/0204; B60J 3/04; G02F 1/1533; G02F 1/163

(57) ABSTRACT

A vehicle anti-glare device includes a light shield that changes light transmittance of irradiated light; an illuminance detector that detects received light intensity of the irradiated light; a transmittance adjuster that adjusts the light transmittance of the light shield based on the received light intensity; an angle detector that detects an inclination angle of the illuminance detector; and a light shielding control unit that changes a relationship of the received light intensity and the light transmittance of the light shield based on the inclination angle to obtain an anti-glare effect that is in accordance with the inclination angle and the received light intensity.

### BACKGROUND

### 1. Field

The present disclosure relates to a vehicle anti-glare device and a method for controlling light transmittance.

### 2. Description of Related Art

A known vehicle anti-glare device decreases the light directed toward an occupant of a vehicle to reduce glare. Japanese Laid-Open Patent Publication No. 2002-321529 discloses a sun visor that is one type of an anti-glare device. The sun visor disclosed in the publication includes an illuminance detector that detects the received light intensity of irradiated light and a light shield that changes the transmittance of light based on the received light intensity. The sun visor is pivotally fixed to the vehicle.

The angle of the illuminance detector with respect to the irradiated light affects the received light intensity detected by the illuminance detector. For example, pivoting of the sun visor will alter the inclination angle of the illuminance detector and change the received light intensity. Thus, the light transmittance of the light shield would be changed even when the intensity of irradiated light is constant, and the optimal anti-glare effect would not be obtained.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first general aspect, a vehicle anti-glare device includes a light shield that changes light transmittance of irradiated light; an illuminance detector that detects received light intensity of the irradiated light; a transmittance adjuster that adjusts the light transmittance of the light shield based on the received light intensity; an angle detector that detects an inclination angle of the illuminance detector; and a light shielding control unit that changes a relationship of the received light intensity and the light transmittance of the light shield based on the inclination angle to obtain an anti-glare effect that is in accordance with the inclination angle and the received light intensity.

In another general aspect, a method for controlling light transmittance includes detecting received light intensity of irradiated light with an illuminance detector; and adjusting light transmittance of a light shield based on the received light intensity of the irradiated light. The adjusting light transmittance includes detecting an inclination angle of the illuminance detector, and changing a relationship of the received light intensity and the light transmittance of the light shield based on the inclination angle to obtain an anti-glare effect that is in accordance with the inclination angle and the received light intensity.

Other features and aspects will be apparent from the following detailed description, the drawings, and the claims.

### BRIEF DESCRIPTION OF THE DRAWINGS

FIG. 1 is a schematic diagram illustrating a vehicle anti-glare device according to one embodiment.

FIG. 2 is a schematic block diagram illustrating a control device of the vehicle anti-glare device.

FIG. 3 is a diagram illustrating pivoting of the vehicle anti-glare device.

FIG. 4 is a diagram illustrating the vehicle anti-glare device irradiated with irradiated light.

FIG. 5 is a diagram illustrating the vehicle anti-glare device irradiated with irradiated light at an angle differing from FIG. 4.

FIG. 6 is a diagram illustrating the relationship of an illuminance detector and irradiated light (irradiation angle).

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

One embodiment of a vehicle anti-glare device 1 will now be described with reference to FIGS. 1 to 6.

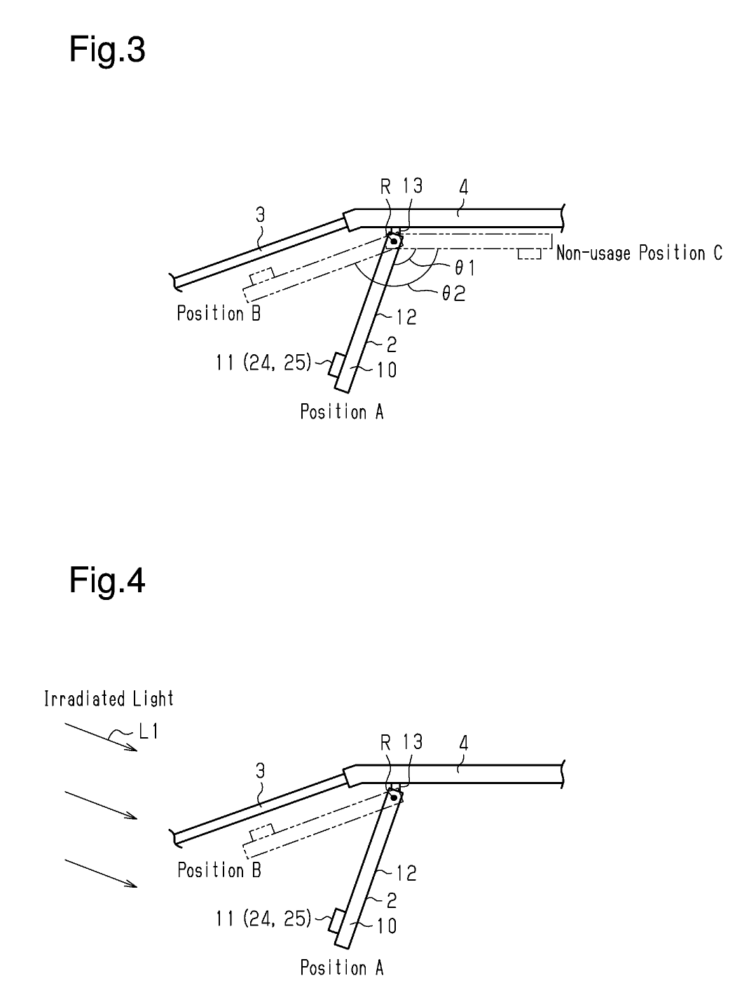

Referring to FIG. 1, the vehicle anti-glare device 1 refers to a sun visor 2 in the present example and is arranged near a windshield glass 3 inside a vehicle (refer to FIG. 3). The vehicle anti-glare device 1 includes a case 10, which serves as a support body, pivotally attached to a support 13 mounted on the ceiling inside the vehicle. The case 10 is configured to pivot about an axis R of the support 13 between a position close to the ceiling of the vehicle and a position close to the windshield glass 3. The case 10 is flat and includes a rectangular opening.

The case 10 includes a light shield 12 for anti-glaring that decreases (shields) the light directed toward an occupant of the vehicle. The light shield 12 has variable light transmittance. For example, the light shield 12 includes an electrochromic element that is colored in accordance with the applied voltage to change the light transmittance. By employing the electrochromic element, the light shield 12 can be used as a transparent display when no voltage is applied.

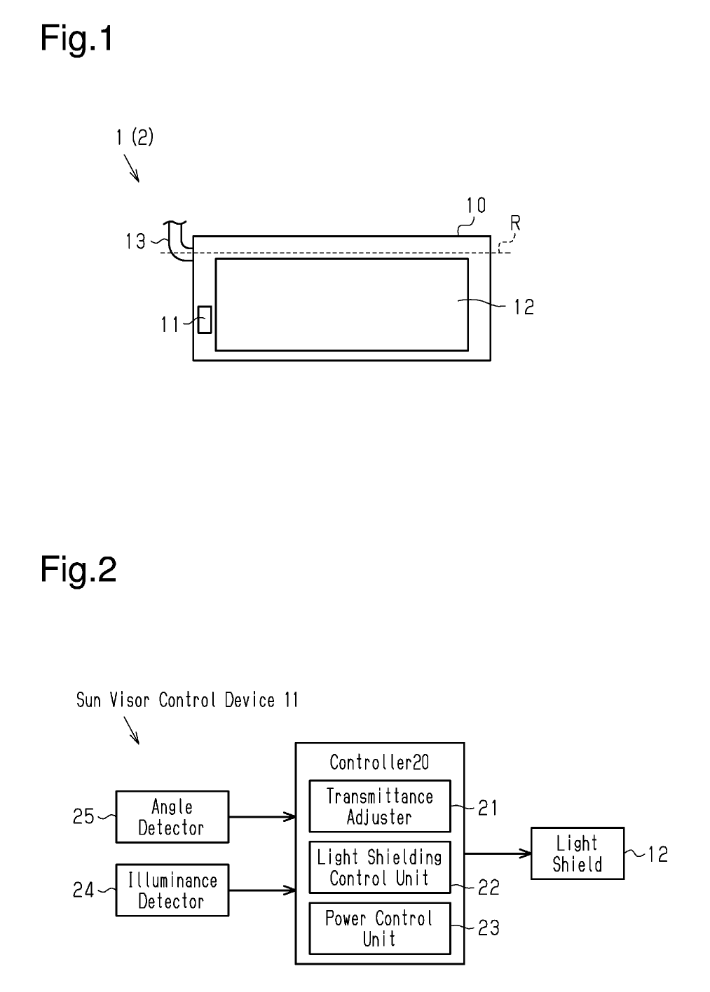

As illustrated in FIGS. 1 and 2, the case 10 includes a sun visor control device 11 that controls light shielding of the vehicle anti-glare device 1. The sun visor control device 11 includes a controller 20 that controls the functions of the sun visor 2 (see FIG. 2).

The sun visor control device 11 includes an illuminance detector 24 that detects the received light intensity of the irradiated light. The illuminance detector 24 may include, for example, a known illuminance detector. The illuminance detector 24 is electrically connected to the controller 20. In the case of the sun visor 2, the illuminance detector 24 is arranged on a surface that can be opposed to the windshield glass 3 and detects the received light intensity of the irradiated light striking the sun visor 2 from outside the vehicle.

The sun visor control device 11 further includes a transmittance adjuster 21 that adjusts the light transmittance of the light shield 12. The transmittance adjuster 21 is arranged in the controller 20. The transmittance adjuster 21, for example, lowers the light transmittance of the light shield 12 as the received light intensity detected by the illuminance detector 24 increases.

The sun visor control device 11 further includes an angle detector 25 that detects the inclination angle of the illuminance detector 24. In the present example, the light shield 12, the illuminance detector 24, and the angle detector 25 are coupled to the case 10, which serves as a single support body. The angle detector 25 includes, for example, a three-axis acceleration sensor. The angle detector 25 is electrically connected to the controller 20. In a case where the angle detector 25 is the acceleration sensor, the controller 20 calculates the inclination angle of the illuminance detector 24 from the acceleration detected by the angle detector 25. In the present example, the illuminance detector 24 and the angle detector 25 are coupled to the sun visor 2. Thus, the inclination angle of the sun visor 2 corresponds to the inclination angle of the illuminance detector 24.

The sun visor control device 11 further includes a light shielding control unit 22 that adjusts the light shield effect that is perceived by a user. The light shielding control unit 22 is arranged in the controller 20. The light shielding control unit 22 changes the relationship of the received light intensity detected by the illuminance detector 24 and the light transmittance of the light shield 12 based on the inclination angle detected by the angle detector 25. In the present example, the controller 20 includes a memory (not illustrated) that stores a data table (light transmittance table) that has inclination angles and received light intensities as assigned values (e.g., parameters arranged in columns and rows) and values of light transmittance as output values according to combinations of the received light intensity and the inclination angle. The light shielding control unit 22 refers to the data table and sets the relationship of the received light intensity and the light transmittance in correspondence with the inclination angle of the illuminance detector 24.

The controller 20 includes a power control unit 23 that controls the power supplied to each portion of the sun visor 2 (vehicle anti-glare device 1). The power control unit 23 limits the supply of power to portions of the sun visor 2 when the sun visor 2 is not used by the occupant. In the present example, the power control unit 23 controls the supply of power based on the inclination angle detected by the angle detector 25.

The operations of the sun visor 2 will now be described with reference to FIGS. 3 to 6. In the following description, it is assumed that the irradiated light from outside the vehicle is sunlight, the irradiated light strikes the sun visor 2 at a constant intensity and constant incident angle, the vehicle is kept level, and the relative angle of the irradiated light entering the vehicle is unchanged.

As illustrated in FIG. 3, the sun visor 2 is pivotal about the axis R of the support 13. In the present example, non-usage position C at which the sun visor 2 is horizontal near a ceiling 4 is referred to as a reference position where the inclination angle of the sun visor 2 relative to a horizontal plane (non-usage position C in present embodiment) is zero degrees (reference angle). When the sun visor 2 is at non-usage position C, the illuminance detector 24 is directed downward in the vertical direction. A position at which the sun visor 2 is pivoted by inclination angle θ1 from non-usage position C toward the windshield glass 3 is referred to as position A. A position at which the sun visor 2 is pivoted by inclination angle θ2 (θ2>θ1) from non-usage position C toward the windshield glass 3 is referred to as position B.

The inclination angle of the illuminance detector 24 may be referred to as a pivotal angle of the sun visor 2 from the reference position (non-usage position C in the present example). Thus, the angle detector 25 detects inclination angle θ1 of the illuminance detector 24 at position A and inclination angle θ2 of the illuminance detector 24 at position B.

As illustrated in FIG. 4, when the sun visor 2 at position A is irradiated with irradiated light L1, the illuminance detector 24 detects the received light intensity of irradiated light L1 orthogonally striking the sun visor 2 (illuminance detector 24). When the sun visor 2 at position B is irradiated with irradiated light L1, the illuminance detector 24 detects the received light intensity of irradiated light L1 diagonally striking the sun visor 2 (illuminance detector 24). Irradiated light L1 is defined as light entering the sun visor 2 at a first incident angle (in present example, 0 degree (°) when the sun visor 2 is at a first position (position A in FIG. 4, that is, inclination angle θ1 in FIG. 2) and entering the sun visor 2 at a second incident angle, which is greater than the first incident angle, when the sun visor 2 is at a second position (position B in FIG. 4, that is, inclination angle θ2 in FIG. 2).

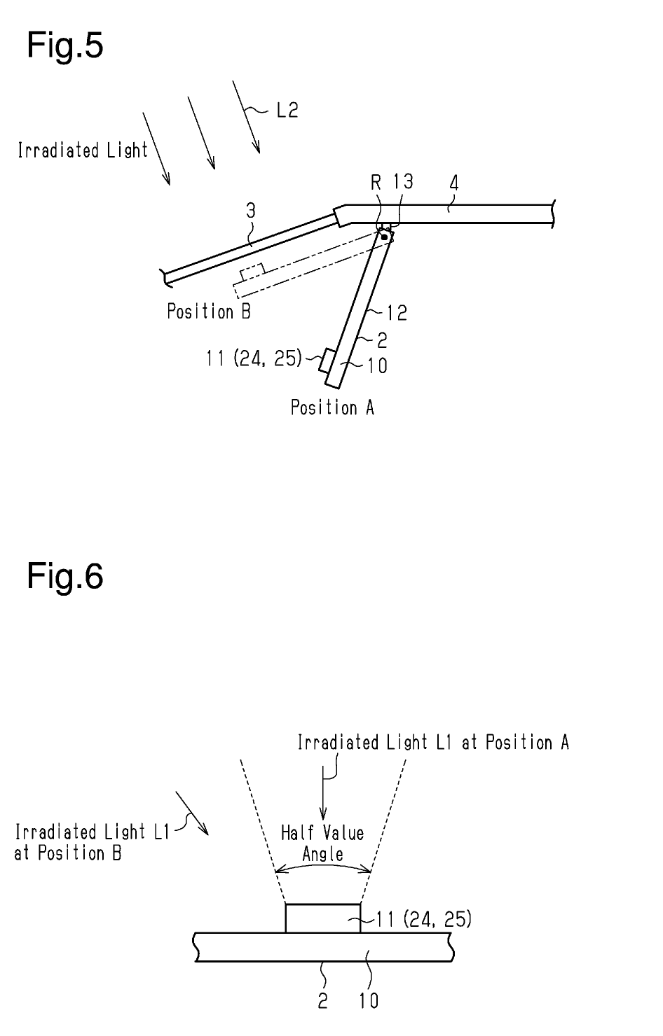

As illustrated in FIG. 5, when the sun visor 2 at position A is irradiated with irradiated light L2 at an incident angle that differs from irradiated light L1, the illuminance detector 24 detects the received light intensity of irradiated light L2 diagonally striking the sun visor 2 (illuminance detector 24). When the sun visor 2 at position B is irradiated with irradiated light L2, the illuminance detector 24 detects the received light intensity of irradiated light L2 orthogonally striking the sun visor 2 (illuminance detector 24). Irradiated light L2 is defined as light entering the sun visor 2 at the first incident angle (in present example, 0 degree) when the sun visor 2 is at the second position (position B in FIG. 5) and entering the sun visor 2 at the second incident angle greater than the first incident angle when the sun visor 2 is at the first position (position A in FIG. 5).

As illustrated in FIGS. 4 and 6, irradiated light L1 is received within a half-value angle range of the illuminance detector 24 at position A where irradiated light L1 orthogonally strikes the illuminance detector 24. In contrast, the illuminance detector 24 at position B cannot receive irradiated light L1 within the half-value angle range. Thus, the received light intensity of irradiated light L1 detected by the illuminance detector 24 at position B is decreased from position A. This is because when the intensity of the irradiated light (luminous flux) is constant, the received light intensity of the irradiated light diagonally striking the illuminance detector 24 is decreased from that of the light orthogonally striking the illuminance detector 24.

In a case where the angle detector 25 and the light shielding control unit 22 are omitted, the transmittance adjuster 21 will adjust the light transmittance of the light shield 12 based on only the received light intensity detected by the illuminance detector 24. When the light shield 12 is moved (inclined) from position A to position B, the received light intensity of irradiated light L1 at position B is decreased from position A as described above. Thus, the transmittance adjuster 21 will raise the light transmittance and lower the light shielding degree of the light shield 12. However, the relative angle of irradiated light L1 entering the vehicle (user) will not change and the user may be dazzled by the glare. In this manner, the anti-glare effects may be adversely affected.

Irradiated light L2 (see FIG. 5) diagonally strikes the sun visor 2 (illuminance detector 24) at position A and orthogonally strikes the sun visor 2 (illuminance detector 24) at position B. When the light shield 12 is moved (inclined) from position A to position B, the received light intensity of irradiated light L2 at position B is increased from position A. Thus, without the angle detector 25 and the light shielding control unit 22, the transmittance adjuster 21 will lower the light transmittance and raise the light shielding degree of the light shield 12. This may narrow the field of view of the user or darken the passenger compartment even though the relative angle of irradiated light L2 entering the vehicle (user) remains unchanged. Thus, the user may feel uncomfortable.

In the present example, the light shielding control unit 22 changes the relationship of the received light intensity and the light transmittance based on the inclination angle of the illuminance detector 24 detected by the angle detector 25. In other words, the light shielding control unit 22 corrects the relationship of the received light intensity and the light transmittance in accordance with the inclination angle. The transmittance adjuster 21 adjusts the light transmittance of the light shield 12 in accordance with the relationship corrected by the light shielding control unit 22.

For example, when the received light intensity increases from a first intensity to a second intensity due to a change in the inclination angle of the illuminance detector 24 from a first angle to a second angle (e.g., movement of light shield 12 from position A to position B in FIG. 5), the light shielding control unit 22 corrects the relationship of the received light intensity and the light transmittance so that the light transmittance corresponding to the second intensity at the second angle (i.e., in relationship after correction) is raised (namely, light shielding degree is lowered) from the light transmittance corresponding to the second intensity at the first angle (i.e., in relationship prior to correction).

When the received light intensity decreases to the first intensity from the second intensity due to a change in the inclination angle of the illuminance detector 24 from the first angle to the second angle (e.g., movement of light shield 12 from position A to position B in FIG. 4), the light shielding control unit 22 corrects the relationship of the received light intensity and the light transmittance so that the light transmittance corresponding to the first intensity at the second angle (i.e., in relationship after correction) is lowered (namely, light shielding degree is raised) from the light transmittance corresponding to the first intensity at the first angle (i.e., in relationship prior to correction).

In the present example, the transmittance adjuster 21 adjusts the light transmittance of the light shield 12 in this manner based on the received light intensity detected by the illuminance detector 24 and the inclination angle detected by the angle detector 25. Thus, for example, when irradiated light L1 enters the vehicle and the light shield 12 is pivoted from position A to position B (see FIG. 4), the received light intensity detected by the illuminance detector 24 decreases. In this case, the relationship of the received light intensity and the light transmittance is corrected based on a detected inclination angle so that the user will feel that the light shield effect is constant regardless of the inclination angle of the light shield 12 (illuminance detector 24). Further, when irradiated light L2 enters the vehicle and the light shield 12 is pivoted from position A to position B (see FIG. 5), the received light intensity detected by the illuminance detector 24 increases. Also in this case, the relationship of the received light intensity and the light transmittance is corrected based on a detected inclination angle so that the user will feel that the light shield effect is constant regardless of the inclination angle of the light shield 12 (illuminance detector 24). This maintains the anti-glare effect irrespective of the position of the light shield 12.

Optionally, the pivotal range of the sun visor 2 from non-usage position C to a predetermined angle position may be set as a non-usage range of the sun visor 2. The power control unit 23 may stop supplying power to the illuminance detector 24 and the light shield 12 when the sun visor 2 is in the non-usage range because the occupant will most likely not be using the sun visor 2. This reduces the power consumed by the sun visor 2.

In the above example, the inclination angle of the illuminance detector 24 relative to the irradiated light changes when the sun visor 2 is pivoted. If the vehicle is inclined relative to a horizontal plane when, for example, the vehicle is driven on a slope, the relative angle of irradiated light entering the vehicle may change. In such a case, the relative angle of the irradiated light striking the illuminance detector 24 changes thereby changing the received light intensity detected by the illuminance detector 24. In this case, since the angle detector 25 includes an acceleration sensor, the change in the relative angle of the light striking the illuminance detector 24 is detected from a change in acceleration in accordance with the inclination of the vehicle. Although the actual inclination angle of the illuminance detector 24 (sun visor 2) relative to the ceiling 4 of the vehicle is not changed under such a situation, the light shielding control unit 22 determines that the change in the relative angle of the irradiated light striking the illuminance detector 24 is a change in the inclination angle of the illuminance detector 24. This allows the transmittance adjuster 21 to change the light transmittance of the light shield 12 based on the received light intensity and the inclination angle to obtain the optimal anti-glare effect.

The above vehicle anti-glare device 1 (sun visor 2) has the advantages described below.

(1) The angle detector 25 detects the inclination angle of the illuminance detector 24, and the light shielding control unit 22 changes the relationship of the received light intensity detected by the illuminance detector 24 and the light transmittance of the light shield 12 based on the detected inclination angle. Thus, even when the inclination angle of the illuminance detector 24 is changed, a suitable light transmittance is set in accordance with the inclination angle and the received light intensity. This obtains the preferred anti-glare effect.

(2) The light shield 12, the illuminance detector 24, and the angle detector 25 are coupled to the case 10, which serves as a single support body. The case 10 is removably attached to the support 13. This allows for easy removal or attachment of the sun visor 2 to the vehicle. As compared when separately laying out these components on the vehicle, coupling to the vehicle is simplified and manufacturing costs are reduced. Further, the light shield 12, the illuminance detector 24, and the angle detector 25 are coupled to the single support body so that the positional relationship of these components is fixed. This is further advantageous for obtaining the preferred anti-glare effect.

(3) When the angle detector 25 detects that the inclination angle of the illuminance detector 24 is in the non-usage range of the light shield 12, the power control unit 23 limits the supply of power to portions of the vehicle anti-glare device 1 (illuminance detector 24 and light shield 12 in the present example). Thus, the vehicle anti-glare device 1 consumes less power.

(4) The angle detector 25 includes an acceleration sensor. The acceleration sensor is not in mechanical contact with a pivotal portion (support 13). Thus, no mechanical wear such abrasion occurs. This improves the durability of the sun visor 2. The use of the acceleration sensor allows for detection of the relative angle of the irradiated light striking the illuminance detector 24 (namely, the absolute angle of irradiated light relative to reference position) rather than the angle of the sun visor 2 (illuminance detector 24) relative to the vehicle (ceiling 4). Thus, the inclination angle of the illuminance detector 24 is calculated even when the relative angle of the irradiated light entering the vehicle changes when, for example, the vehicle is driven on a slope. This obtains the preferred anti-glare effect.

It should be apparent to those skilled in the art that the foregoing embodiments may be implemented in many other specific forms without departing from the scope of this disclosure. Particularly, it should be understood that the foregoing embodiments may be implemented in the following forms.

In the above embodiment, the acceleration sensor used in the angle detector 25 may be any non-contact sensor such as an angular rate sensor or gravity sensor, which is not in mechanical contact with the pivotal portion (support 13).

In the above embodiment, the acceleration sensor for the angle detector 25 may be replaced with any contact sensor, which detects an angle through mechanical contact with the pivotal portion. However, a non-contact sensor will improve the durability of the sun visor 2 because a non-contact sensor such as an acceleration sensor is less prone to mechanical wear than a contact sensor.

In the above embodiment, the vehicle anti-glare device 1 does not have to include the power control unit 23. The power control unit 23 is a removable element because it is a functional unit that reduces power consumption and does not affect the anti-glare effect.

In the above embodiment, the light shield 12, the illuminance detector 24, and the angle detector 25 do not have to be coupled to the same support body (case 10). For example, the light shield 12 may be arranged to serve as a sun visor, and the illuminance detector 24 and the angle detector 25 may be arranged on a dashboard or the like. In this case, the anti-glare effect is optimized when the angle detector 25 detects the inclination angle of the illuminance detector 24 and the light transmittance of the light shield 12 is changed when necessary. The arrangement of the light shield 12, the illuminance detector 24, and the angle detector 25 is not particularly limited as long as the angle detector 25 detects the inclination angle of the illuminance detector 24 as described above. However, when coupling these elements to the same support body, coupling of the elements is simplified. Further, these components are easily attached and removed.

The reference position for the inclination angle of the illuminance detector 24 is not limited as described in the above embodiment. Position A, for example, may be set as the reference position instead of non-usage position C. Further, when the light shield 12 and the illuminance detector 24 are separate, for example, separate reference positions may be set. The reference position for the inclination angle may be set when necessary in accordance with, for example, the arrangement position of the illuminance detector 24.

In the above embodiment, the data table in which received light intensity and inclination angles are arranged in a matrix is used to change the relationship of the received light intensity and the light transmittance. The data table does not have to be particularly used to control of the light transmittance. The use of the data table may be replaced with the use of a function expression, for example, which is defined with two parameters of received light intensity and an inclination angle. Alternatively, sensitivity of the illuminance detector 24 may be changed in response to an output signal of the angle detector 25 in accordance with the inclination angle. This also obtains the optimal anti-glare effect based on the inclination angle of the illuminance detector 24.

In the above embodiment, the mechanism for changing the light transmittance of the light shield 12 is not particularly limited. The electrochromic element may be replaced with a photochromic element, a transmissive liquid crystal element, or the like as the mechanism for changing the light transmittance.

In the embodiment, the transmittance adjuster 21 may change the light transmittance in a continuous or non-continuous manner or switch on and off the light shielding function (lowering of light transmittance) of the light shield 12 based on the received light intensity and the inclination angle. For example, a threshold value may be set for the received light intensity. If the received light intensity is greater than the threshold value, the light shield function is activated. If the received light intensity is less than or equal to the threshold value, the light shielding function is deactivated. In this case, the light shielding control unit 22 maintains the anti-glare effect by changing the threshold value in accordance with the inclination angle.

In the embodiment, the vehicle anti-glare device 1 is not limited to the sun visor 2 of a vehicle. Elements other than the light shield 12 may be arranged at predetermined portions in the vehicle so that the elements function in cooperation with the light shield 12. Alternatively, the vehicle anti-glare device 1 may be, for example, retrofitted to a sun visor in the vehicle.

In the above embodiment, the method for supplying power to the sun visor 2 is not limited. Power may be supplied from a battery of the vehicle or a battery cell accommodated in the sun visor 2. In either case, the power control unit 23 reduces unnecessary power consumption.

The above embodiment and one or more of the above modified examples may be appropriately combined.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle anti-glare device comprising:
a light shield that changes light transmittance of irradiated light;
an illuminance detector that detects received light intensity of the irradiated light;
a transmittance adjuster that adjusts the light transmittance of the light shield based on the received light intensity;
an angle detector that detects an inclination angle of the illuminance detector; and
a light shielding control unit that changes a relationship of the received light intensity and the light transmittance of the light shield based on the inclination angle to obtain an anti-glare effect that is in accordance with the inclination angle and the received light intensity.

2. The vehicle anti-glare device according to claim 1, comprising a single support body to which the light shield, the illuminance detector, and the angle detector are coupled.

3. The vehicle anti-glare device according to claim 1, comprising a power control unit that limits supply of power to a portion of the vehicle anti-glare device when the angle detector detects that the inclination angle of the illuminance detector is in a non-usage range of the light shield.

4. The vehicle anti-glare device according to claim 1, wherein the illuminance detector includes an acceleration sensor.

5. The vehicle anti-glare device according to claim 1, wherein when the received light intensity increases from a first intensity to a second intensity due to a change in the inclination angle from a first angle to a second angle, the light shielding control unit corrects the relationship of the received light intensity and the light transmittance so that the light transmittance corresponding to the second intensity at the second angle is raised from the light transmittance corresponding to the second intensity at the first angle.

6. The vehicle anti-glare device according to claim 1, wherein when the received light intensity decreases to a first intensity from a second intensity due to a change in the inclination angle from a first angle to a second angle, the light shielding control unit corrects the relationship of the received light intensity and the light transmittance so that the light transmittance corresponding to the first intensity at the second angle is lowered from the light transmittance corresponding to the first intensity at the first angle.

7. A method for controlling light transmittance, the method comprising:
detecting received light intensity of irradiated light with an illuminance detector; and
adjusting light transmittance of a light shield based on the received light intensity of the irradiated light, wherein
the adjusting light transmittance includes
detecting an inclination angle of the illuminance detector, and
changing a relationship of the received light intensity and the light transmittance of the light shield based on the inclination angle to obtain an anti-glare effect that is in accordance with the inclination angle and the received light intensity.
